(19) United States
(12) Patent Application Publication
(10) Pub. No.: US 2024/0086941 A1
(43) Pub. Date: Mar. 14, 2024

(54) SYSTEMS AND METHODS TO IDENTIFY TECHNOGRAPHICS FOR A COMPANY

(71) Applicant: 6SENSE INSIGHTS INC., San Francisco, CA (US)

(72) Inventors: Gajanan SABHAHIT, Karnataka (IN); Roopam CHOUDHURY, Assam (IN); Mounarajan PARTHIBAN, Nadu (IN); Tarun BANSAL, Delhi (IN); Pratyush BEHERA, Odisha (IN); Arjab SARKAR, West Bengal (IN)

(21) Appl. No.: 18/204,574

(22) Filed: Jun. 1, 2023

Related U.S. Application Data
(63) Continuation of application No. PCT/IB2023/050413, filed on Jan. 18, 2023.

(30) Foreign Application Priority Data
Sep. 8, 2022 (IN) 202221051374

(51) Int. Cl. G06Q 30/0201; G06F 16/951

(52) U.S. Cl. CPC G06Q 30/0201; G06F 16/951

(57) ABSTRACT

A system and a method for identifying technographics for by a company are disclosed. Initially, the system may receive a list of web addresses associated with a company identifier. Further, the system may parse each web address to extract patterns related to the technology using a set of techniques. Furthermore, the system may create a file comprising the extracted patterns for each of the set of techniques. The files created from each technique may be compiled to generate compiled data. The compiled data comprises a mapping of the extracted patterns related to the technology with the corresponding set of techniques against the company identifier. Further, the system may identify the technology currently being used by the company by comparing the compiled data with the predefined pattern file of each technique.

### PRIORITY INFORMATION

The present application is a bypass continuation of International Patent Application No. PCT/IB2023/050413, filed on Jan. 18, 2023, which claims priority from Indian Application No. 202221051374, filed on 08th Sep., 2022, which are both hereby incorporated herein by reference as if set forth in full.

### TECHNICAL FIELD

The present subject matter described herein, in general, relates to, identifying technographics for a company and more particularly, to identify technology used by the company.

### BACKGROUND

In the age of the digital world, an enormous amount of data is available on the internet. An organization may require such data to approach a client for offering their product or service range. However, the data is diversified and is present in an unstructured format. In most organizations, sales and marketing teams spend time and effort targeting prospect companies that might not be a good fit for their products or services. Data and patterns available across the internet can be analyzed to churn out useful information that the sales and marketing teams can use to reach the right prospects at the right time.

### SUMMARY

Before the present system(s) and method(s), are described, it is to be understood that this application is not limited to the particular system(s), and methodologies described, as there can be multiple possible embodiments that are not expressly illustrated in the present disclosures. It is also to be understood that the terminology used in the description is for the purpose of describing the particular implementations or versions or embodiments only and is not intended to limit the scope of the present application. This summary is provided to introduce aspects related to a system and a method for identifying technology used by a company. This summary is not intended to identify essential features of the claimed subject matter nor is it intended for use in determining or limiting the scope of the claimed subject matter.

In one implementation, a method for identifying technology used by a company is disclosed. A list of web addresses associated with a company identifier may be received. Further, each web address may be parsed to extract patterns related to one or more technologies using a set of techniques. Subsequently, a file comprising the extracted patterns may be created for each of the set of techniques. Further, the files created from each technique may be compiled to generate compiled data. The compiled data may comprise a mapping of the extracted patterns related to the technology with the corresponding the set of techniques against the company identifier. Finally, the technology currently being used by the company may be identified by comparing the compiled data with a prestored pattern file for each technique. It may be noted that the extracted patterns in the compiled data is compared with predefined patterns in the pattern file for each technique using a set of string matching algorithms. In one aspect, the aforementioned method for identifying technology used by a company may be performed by a processor using programmed instructions stored in a memory.

In another implementation, a non-transitory computer-readable medium embodying a program executable in a computing device for identifying technology used by a company is disclosed. The program may comprise a program code for receiving a list of web addresses associated with a company identifier. Further, the program may comprise a program code for parsing each web address for extracting patterns related to the technology using a set of techniques. Subsequently, the program may comprise a program code for creating a file comprising the extracted patterns for each of the set of techniques. Furthermore, the program may comprise a program code for compiling the files created for each technique to generate compiled data. It may be noted that the compiled data may comprise a mapping of the patterns related to the technology with the corresponding set of techniques against the company identifier. Finally, the program may comprise a program code for identifying the technology currently being used by the company by comparing the compiled data with a prestored pattern file of each technique. It may be noted that the extracted patterns in the compiled data is compared with predefined patterns in the pattern file for each technique using a set of string matching algorithms

### BRIEF DESCRIPTION OF THE DRAWINGS

The foregoing detailed description of embodiments is better understood when read in conjunction with the appended drawings. For the purpose of illustrating the present subject matter, an example of a construction of the present subject matter is provided as figures, however, the invention is not limited to the specific method and system for identifying technology used by a company disclosed in the document and the figures.

The present subject matter is described in detail with reference to the accompanying figures. In the figures, the left-most digit(s) of a reference number identifies the figure in which the reference number first appears. The same numbers are used throughout the drawings to refer to various features of the present subject matter.

FIG. 1 illustrates a network implementation for identifying technology used by a company, in accordance with an embodiment of the present subject matter.

FIG. 2 illustrates the set of techniques used for extracting the patterns related to the technology, in accordance with an embodiment of the present subject matter.

FIG. 3 illustrates an example of the compiled data related to the technology, in accordance with an embodiment of the present subject matter.

FIG. 4 illustrates an example of technographic data, in accordance with an embodiment of the present subject matter.

FIG. 5 illustrates a method for identifying technology used by a company, in accordance with an embodiment of the present subject matter.

FIG. 6 illustrates an example view of an embedding space, in accordance with an embodiment of the present subject matter.

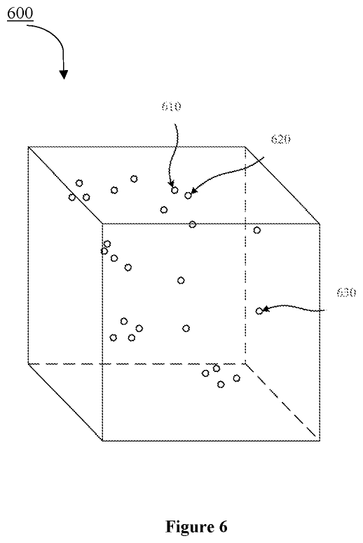

The figure depicts an embodiment of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

Some embodiments of this disclosure, illustrating all its features, will now be discussed in detail. The words “receiving,” “parsing,” “creating,” “compiling,” “identifying,” and other forms thereof, are intended to be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise. Although any system and methods similar or equivalent to those described herein can be used in the practice or testing of embodiments of the present disclosure, the exemplary, system and methods are now described.

The disclosed embodiments are merely examples of the disclosure, which may be embodied in various forms. Various modifications to the embodiment will be readily apparent to those skilled in the art and the generic principles herein may be applied to other embodiments. However, one of ordinary skill in the art will readily recognize that the present disclosure is not intended to be limited to the embodiments described but is to be accorded the widest scope consistent with the principles and features described herein.

Technographics is a combination of the word's “technology” and “demographics”. Simply put, technographic data is defined as data that help businesses identify technologies of interest to one or more companies. In essence, technographic data helps to understand the technology and technical tools used by the target company. The technographic data helps to understand when a customer (a lead or a client) might have started using a particular technology and when the contract or subscription is expected to renew, in addition to giving the user a high-level overview of a company's tech stack. Thus, helping the user (marketing team or sales team) effectively market to the companies or accounts that are likely to explore the users' offerings.

The present subject matter discloses a method and a system for identifying technology used by a company. The technographic data helps the company identify the target or potential customers (or companies or clients or leads) looking for products or services offered by the company. In order to identify the technographic data of the company, the system may receive a list of web addresses associated with a company identifier. Further, the system may parse each web address to identify at least a technology currently being used by the company. The system may parse each web address by extracting patterns related to the technology using a set of techniques. The set of techniques may comprise HyperText Markup Language (HTML) crawling, subdomain check, job listing data and employee profile data analysis, JavaScript (JS) rendering, Name Server (NS) lookup, Mail Exchange (MX) lookup, and Text (TXT) Records.

The term pattern as used herein refers to information for mapping the patterns to the technology. It may be noted that patterns related to the technology usage may exist in the public domain in different storages and types. In an embodiment, the data may exist in the fragments of the code that built up the website or maybe available in the career's pages. Further, it may be noted that the patterns are dynamic over different timeframes. In other words, the patterns may evolve or modify or completely change over a period of time. Hence, continuous curation of patterns for technologies is required. Further, the patterns may be inconsistent across similar technologies i.e., technologies within the same category or subcategory may have completely different types of patterns. In some embodiments, the pattern may also be referred to as a Digital Footprint (DF). The patterns can uniquely be attributed to one specific technology at any given time. It may be noted that two technologies cannot have the same pattern (s) unless the two technologies are two modules of the same product or two versions of the same product.

After extracting the patterns, a file comprising the extracted patterns for each of the set of techniques is created. Further, the extracted patterns may be validated and compiled data comprising a mapping of the patterns related to the technology from the set of techniques may be created. The system is also configured to display the technologies used by the company (technographic) along with a confidence score. In an embodiment, the technographic data may help a sales team to identify potential buyers in the market.

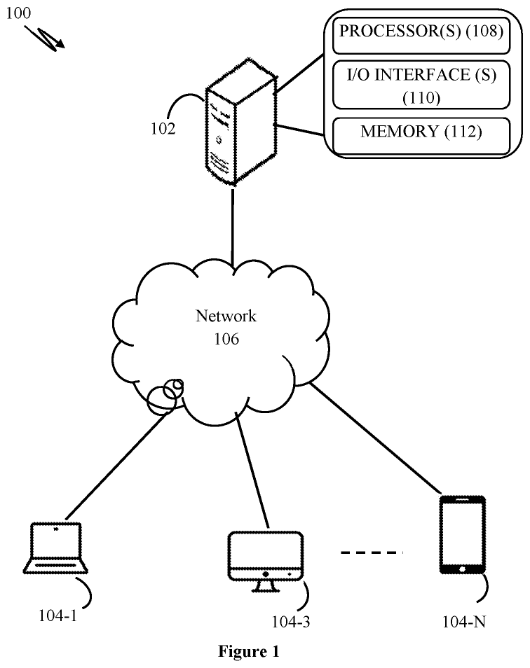

Referring now to FIG. 1, a network implementation 100 of a system 102 for identifying technology used by a company is disclosed. Initially, the system 102 receives a list of web addresses associated with a company identifier. In an example, a software may be installed on a user device 104-1. It may be noted that the one or more users may access the system 102 through one or more user devices 104-2, 104-3 . . . 104-N, collectively referred to as user devices 104, hereinafter, or applications residing on the user devices 104. The system 102 receives the list of web addresses associated with a company identifier from one or more user devices 104. Further, the system 102 may also receive a feedback from a user using the user devices 104.

Although the present disclosure is explained considering that the system 102 is implemented on a server, it may be understood that the system 102 may be implemented in a variety of computing systems, such as a laptop computer, a desktop computer, a notebook, a workstation, a virtual environment, a mainframe computer, a server, a network server, a cloud-based computing environment. It will be understood that the system 102 may be accessed by multiple users through one or more user devices 104-1, 104-2 . . . 104-N. In one implementation, the system 102 may comprise the cloud-based computing environment in which the user may operate individual computing systems configured to execute remotely located applications. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network, or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

In one embodiment, the system 102 may include at least one processor 108, an input/output (I/O) interface 110, and a memory 112. The at least one processor 108 may be implemented as one or more microprocessors, microcomputers, microcontrollers, digital signal processors, Central Processing Units (CPUs), state machines, logic circuitries, and/or any devices that manipulate signals based on operational instructions. Among other capabilities, the at least one processor 108 is configured to fetch and execute computer-readable instructions stored in the memory 112.

The I/O interface 110 may include a variety of software and hardware interfaces, for example, a web interface, a graphical user interface, and the like. The I/O interface 110 may allow the system 102 to interact with the user directly or through the client devices 104. Further, the I/O interface 110 may enable the system 102 to communicate with other computing devices, such as web servers and external data servers (not shown). The I/O interface 110 can facilitate multiple communications within a wide variety of networks and protocol types, including wired networks, for example, LAN, cable, etc., and wireless networks, such as WLAN, cellular, or satellite. The I/O interface 110 may include one or more ports for connecting a number of devices to one another or to another server.

The memory 112 may include any computer-readable medium or computer program product known in the art including, for example, volatile memory, such as static random-access memory (SRAM) and dynamic random access memory (DRAM), and/or non-volatile memory, such as read only memory (ROM), erasable programmable ROM, flash memories, hard disks, Solid State Disks (SSD), optical disks, and magnetic tapes. The memory 112 may include routines, programs, objects, components, data structures, etc., which perform particular tasks or implement particular abstract data types. The memory 112 may include programs or coded instructions that supplement applications and functions of the system 102. In one embodiment, the memory 112, amongst other things, serves as a repository for storing data processed, received, and generated by one or more of the programs or the coded instructions.

As there are various challenges observed in the existing art, the challenges necessitate the need to build the system 102 for identifying technology used by a company. At first, a user may use the user device 104 to access the system 102 via the I/O interface 110. The user may register the user devices 104 using the I/O interface 110 in order to use the system 102. In one aspect, the user may access the I/O interface 110 of the system 102. The detailed functioning of the system 102 is described below with the help of figures.

The present subject matter describes the system 102 for identifying technology used by a company. The system 102 may receive a list of web addresses associated with a company identifier as an input. In particular embodiments, the system 102 may identify external data sources linked to each web address. The external data sources may comprise at least a blog page, an article related to a company, and a research paper.

Further to receiving the list of web addresses, the system 102 may parse each web address to extract patterns related to the technology using a set of techniques. The set of techniques may comprise at least HyperText Markup Language (HTML) crawling, subdomain check, job listing data and employee profile data analysis, JavaScript (JS) rendering, Name Server (NS) lookup, Mail Exchange (MX) lookup, and Text (TXT) Records.

Further to parsing, a file comprising the extracted patterns for each of the set of techniques may be created. It may be noted that the technology can be identified by single or multiple patterns, hence one to many relations exist while identifying patterns for the technology. The following embodiments will describe the method of extracting patterns relating to a technology by using each of the set of techniques mentioned above.

HTML Crawling

In an embodiment, the parsing each web address to extract patterns based on the HTML crawling technique comprises crawling the list of the web addresses to extract the patterns related to the technology. The system 102 may parse different depth levels or levels of each web address. The depth level of a web address may refer to a number of levels inside a web address and these levels are determined by the number of inputs or clicks a user has to make from a home page to reach a particular web address. For example, a home page may be considered as depth level 0. A web page that is accessed from the home page or depth level 0 is considered as depth level 1. For example, a “team page” may be accessed from the home page. Similarly, a web page that is accessed from depth level 1 is considered as depth level 2, and so on. For example, a “contact us page” may be accessed from the “team page”. In an implementation, each of the plurality of nodes may parse to a certain degree of depth levels for each web address. In another implementation, a user may set a value for the depth level to be parsed by the system such as a depth level of 6.

Subsequently, the system 102 may extract Hypertext Markup Language (HTML) data pertaining to each level of the web address. The HTML data is stored in a storage unit (a memory 112). In an example, the system 102 may interact with different elements of each web address to extract the HTML data. For example, different elements of a web address may include text data, image data, source code of the web address, and so on. The system 102 may then extract a list of HTML patterns for each company based on the HTML data. The list of HTML patterns may be extracted by comparing the HTML data with a prestored HTML pattern file.

Sub-Domain Check

In an embodiment, the parsing of each web address to extract patterns based on the subdomain check for a domain name of the company may comprise creating a technology Uniform Resource Locator (URL) or a pseudo URL for each web address based on a subdomain template file stored in the memory. The subdomain template represents a URL format for the technology. The subdomain template is a combination of at least a technology field, a company field, a domain extension, alphabets, numbers, and special characters. For example, the subdomain template may be “technologyD.com/b/qz15awx2/company”. The pseudo URL for the company may be created by replacing a “company field” with a company name in the subdomain template. In the above example, the pseudo URL for company “ABC” may be technologyD.com/b/qz15awx2/ABC. In another example, the pseudo URL may comprise—“company A.technology.com” or “technology.com/company B” or alike. It may be noted that the pseudo URL is different for different technologies.

The pseudo URL is created by invoking the subdomain templates corresponding to different technologies and by replacing the company field in the subdomain template with at least a company name corresponding to each company. Let us assume that the subdomain template for technology Y is technologyY.company.com. Hence, the pseudo URL for the company T may be technologyY.companyT.com. For company Y it is technologyY.companyY.com. In an embodiment, the pseudo URL may also be created by replacing the company field in the subdomain template with at least a derivative name of the company or an abbreviation of a company (e.g., JDC for john doe company).

Technology companies, web-hosted services or cloud-hosted services provide a subdomain for each client or customer on the service provider's domain (example: client-company.domain.com). It may be noted that the technologies currently being used by a company may be identified by using subdomain templates.

In an embodiment, the number of pseudo URL created for the company is equal to the number of subdomain templates stored in the memory. In an example and not by way of any limitation, let us assume that the number of subdomain templates stored in the memory is 2000. Further, the list of web addresses 5000 URLs. The system may create at least 2000 pseudo URLs, in real time, for each company.

For example, the subdomain templates may comprise subdomain templates for different technologies as shown in Table A and the set of pseudo URLs for a company may comprise pseudo URLs as shown in Table B.

TABLE A
Subdomain templates of technologies

| Technology | Subdomain Template |
|---|---|
| Technology A | company.techA.com |
| Technology B | technologyB.company.com |
| Technology C | technologyC.com/company |
| Technology D | technologyD.com/b/qz15awx2/comapny |

TABLE B
Pseudo URLs are created based on the subdomain
templates shown in Table A

| Web Address | Company | Technology | Pseudo URL |
|---|---|---|---|
| www.abc.com | ABC | Technology A | abc.techA.com |
| | | Technology B | technologyB.abc.com |
| | | Technology C | technologyC.com/abc |
| | | Technology D | technologyD.com/ |
| | | | b/qz15awx2/abc |
| www.xyz.com | XYZ | Technology B | technologyB.xyz.com |
| | | Technology C | technologyC.com/xyz |
| | | Technology B | technologyB.xyz.com |

Further to creating the pseudo URL, the system 102 may access the pseudo URL to determine a status code. The status code helps to identify the technology used by the company. It may be noted that the status codes differ across technology, or the status codes can be same. The status codes are stored in the system for each web address or company. In an embodiment, a right parallelism technique is used to visit multiple pseudo URLs at a time.

The right parallelism technique comprises visiting multiple pseudo URLs by splitting the pseudo URLs among clusters. Further, each cluster, from the clusters, utilizes a plurality of workers to speed up the crawling process and to utilise the machine resources. The right parallelism technique is configurable for each technology based on rate-limiting factor and request-response time. The rate-limiting factor refers to preventing the frequency of an operation from exceeding some constraint. The request response time starts when a request to visit the pseudo URL is provided and ends when the request is completed.

It may be noted that the status code corresponds to a set of HTTP standard response codes to HTTP requests. The status code may be one of a 1xx, a 2xx, a 3xx, a 4xx, and a 5xx response code. The status code obtained by visiting the pseudo URL is mentioned in the below table. It may be noted that the 2xx response code comprises a set of response codes such as 200, 201, 202-208, and 226. In an example and not by way of any limitation, the status code obtained by visiting the pseudo URL may be validated by a user.

TABLE C

| Status Code | Meaning |
|---|---|
| 1xx | Informational |
| 2xx | Successful |
| 3xx | Redirection |
| 4xx | Client Error |
| 5xx | Server Error |

In an embodiment, the system may redirect the pseudo URL to a target website when the obtained status code is 3xx. The target website may be analyzed to identify the technology for the company. Consider an example, the system visits the pseudo URL “techA.abc.com.”. In the example, the system may be redirected to “techA.abc.in”. It may be noted that the system may maintain a list of pseudo URLs that prompts redirection to some other URL. It may be noted that the system may record an instance when the pseudo URL prompts redirection to other URL. In one embodiment, the instance may be stored in the memory.

In another embodiment, the system may invoke a proxy server based upon the status code received from the pseudo URL. In an example and not by way of any limitation, the system invokes the proxy servers when response codes are 305, 306, 407, and alike.

In an aspect, the received status code may be compared with a prestored list of status codes. The prestored list of status codes represent a list of status codes that are active or valid or positive for a particular technology. Further, the prestored list of status codes may be updated automatically or manually.

Consider an example, the prestored list of status codes comprises status codes 200, 202, 206, 207, 302, and 307 as active or valid or positive status codes for technology A. In an example and not by way of any limitation, when the system receives any other status code which is not present in the prestored list of status codes. The system may flag the pseudo URL as invalid.

In another example and not by way of any limitation, the prestored list of status codes may comprise positive status codes and negative status codes for the different technologies. The positive status code and the negative status code may also be referred to as a valid status code and an invalid status code respectively. For example, let us assume the prestored list of status codes as shown in Table D.

TABLE D

| Technology | Status Code | Acknowledgment |
|---|---|---|
| Technology A | 200 | Positive |
| | 404 | Negative |

Further to accessing the pseudo-URL and determining the status code, the system 102 may create a subdomain file comprising the technology and status code tagged to each company identifier.

In the above example (Table D), the system identifies Technology A as a technology used by the company “abc” after comparing “200” with the prestored list of status codes as shown in Table D. The system identifies that “200” is a positive status code for Technology A therefore, the company “abc” is using Technology A.

In an embodiment, the system may update the subdomain templates. The subdomain templates are updated by removing expired subdomain template. In one example, the expired subdomain templates may be removed from the list of subdomain templates by receiving a feedback from a user. In order to elucidate further, let us assume that company P uses technology X. The subdomain pattern for the technology X is techologyX.com/in/company.com. The system may remove the expired subdomain pattern when the system obtains a status code which is not present in the prestored list of status codes. Thus, the system may remove the subdomain pattern-“techologyX.com/in/company.com” from the memory. In the above case, it may have happened that the technology X updated their subdomain URL. In another embodiment, the system may identify the new subdomain pattern for Technology X by parsing web pages related to the technology X.

In an embodiment, after creation of the pseudo URL the system may crawl the pseudo URL based on different crawling modes. The system may use different type of HTTP-requests to obtain the response data.

Below are some examples of HTTP-requests:

### Example 1: HTTP Status Code

request_type: HEAD
follows_redirects: NO
collects: HTTP_response_code and Redirected_URL
filter_order: status_code, return_URL
parallelism: 10

This crawl mode sends a HEAD request and collects response code and redirected URL (if response code is 301, 302 or 303). In this HTTP-request, redirects are not followed, and no HTML, source code is collected.

Consider a scenario: When a “URL-1” is visited or accessed, it may get redirected to “URL-2” and the system may obtain status code 302. Further, the “URL-2” may be redirected to “URL-3” and the system may obtain status code 301. Finally, the “URL-3” may be redirected to “URL-4” and the system may obtain the status code 200 and the webpage is reached.

In the example 1, the system only captures first status code (302) and return URL will be URL 2.

### Example 2: Redirected/Final URL

request_type: HEAD
follows_redirects: YES
collects: HTTP_response_code and final_redirected URL
filter_order: return_url, status_code
parallelism: 10

In this crawl mode the system collects final redirect URL and associated status code. Hence, for example 2, the system obtains “URL-4” and status code 200.

### Example 3: HTML Source of Final Landing Page

request_type: GET
follows_redirects: YES
collects: HTTP_response_code, final_redirected_URL and html_page_source (without loading external JS)
filter_order: return_url, status_code, and final html_page source
parallelism: 10

In this mode the system collects return URL, status code, and HTML Page Source. This mode is bit slower when compared to previous 2 modes as it follows redirects and returns page source along with headers, which can be heavy load at times. The system captures the final page source along with the status code and the return URL. For the above scenario, the system in this crawl mode may obtain HTML page source code of URL-4, status code 200, and the return URL is URL-4.

### Example-4

SUBDOMAIN SELENIUM:
request_type: Selenium-get
driver: chrome
page_load_timeout: 20 s
collects: final_redirect_URL and html_page source (loads ext. JavaScript)
filter_order: pattern
parallelism: 25

If the redirects on the base URL are determined by ext. JS and are not http-redirects, and/or, there is no difference in final_page source except for dynamic content. Filter order can be one or combination of return_url and tracker_pattern. It may be noted that the tracker pattern is a pattern found in the HTML source code of the website. The tracker pattern is compared with a prestored tracker pattern sheet. When the tracker pattern is matched with the prestored tracker pattern sheet then the technology identified for the company is confirmed. The tracker pattern is determined when the obtained status code matches with the prestored list of status code.

Example: Dynamically loaded content is also captured here. This method is useful for technologies like ‘lattice’, where domain-first.latticehq.com′ redirects to ‘lattice.com’ in case of wrong “domain-first”, but this redirect is supported by ext. JS and not server based.

Job Listing Data and Employee Profile Data Analysis

The system may obtain job listing data and employee profile data. The employee profile data may comprise at least a current work profile and past work profile of an employee. It may be noted that the employee is employed with the company. In an embodiment, a user may share a file comprising the job listing data and the employee profile data. In an example, the job listing data may be job details posted by a company for a particular job profile. In another example and not by way of limitation, the employee profile data may comprise a summary related to work profile of the employee.

After obtaining the job listing data and the employee profile data, the system 102 may clean the job listing data and the people summary data by using data cleaning techniques. In an embodiment, the system 102 may remove the special characters (e.g., Exclamation mark, Hyphen, Underscore, etc.) present in the job listing data and the employee profile data.

Further to cleaning, the job listing data and the employee profile data, the system may extract a keyword and a set of buffer keywords from the job listing data and the employee profile data. It may be noted that the keyword corresponds to at least one technology. The set of buffer keywords comprises a plurality of words appearing before and after the keyword in either the job listing data or the employee profile data. In an example and not by way of any limitation, a user may set a value for the length of words appearing before and after the keyword that needs to be extracted. In the example, the user may set the buffer keyword length value as 5. Hence, the system will extract 5 words appearing before and 5 words appearing after the keyword.

Let us assume that the job listing data comprises “3-6 years of experience in designing, configuring, developing, and implementing Salesforce solutions.” In the example, the keyword is Salesforce®. Further, the system may extract “designing, configuring, developing, and implementing Salesforce solutions” as a set of buffer keywords.

Further, the system may determine context of the job listing data and the employee profile data based on the set of buffer keywords related to the keyword. It may be noted that the context of the set of buffer keywords is determined using a machine learning model or machine learning techniques. In an example and not by way of any limitation, the machine learning models used for the context determination may include at least one of set of decision tree, random forest, k-nearest neighbour, support vector machines, naive Bayes classifier, and deep learning by constructing a neural network of multiple hidden layers. It may be noted that the machine learning models are used to build a context-aware model utilizing a given training dataset with contextual information and then the resultant predictive model can be used for testing purposes.

In one embodiment, the training dataset may comprise a vector of the keyword and a dictionary having similar meanings as the keyword, labelled as ground-truth context into the keyword. The dictionary is represented in a vector space with distance vectors originating from the keyword for one or more words present in the dictionary. The machine learning model is trained to determine the context of the extracted set of buffer keywords corresponding to the keyword from the job listing data and the employee profile data. The context is determined when at least a buffer keyword from the set of buffer keyword matches with one or more words present in the dictionary. It may be noted that the machine learning model is continuously under training and learning. The machine learning model is iteratively trained based on the job listing data and the employee profile data.

Consider an example, the system receives job description data comprising—“Development experience in C# NET 4.5 & knowledge of HTML, SQL.” Further, the system determines the keyword (NET 4.5) and the set of buffer keywords appearing before and after the keyword. Let us assume that the pool of keyword of NET 4.5 comprises development, SQL, HTML, and framework. Further, the system determines the context as web development using machine learning model.

Alternatively, the context of the job listing data and the employee profile data may also be determined based on a mapping sheet comprising the dictionary having similar meanings as the keyword. The system may compare the dictionary with the set of buffer keywords. It may be noted that context is determined when one or more keywords from the dictionary are matched with at least a keyword present in the set of buffer keywords.

Furthermore, the system may compare the extracted keywords and the context with corresponding prestored job listing pattern data and prestored employee profile pattern data. It may be noted that the comparison may be performed using string matching algorithms. The string-matching algorithms may be one of Aho-Corasick algorithm, brute force string search, Knuth-Morris-Pratt algorithm, Boyer-Moore, Zhu-Takaoka, quick search, deterministic finite automata string search, Karp-Rabin, Shift-Or Smith algorithm. In an embodiment, the system may perform text mining to compare the keywords and the context with the corresponding prestored job listing pattern data and prestored employee profile pattern data. In another embodiment, matching may be performed using Natural Language Processing (NLP) and Natural Language Understanding (NLU) algorithms. Finally, the system may create a job listing pattern file and an employee profile pattern file when a match is found after the comparison.

In an embodiment, the prestored job listing pattern data and prestored employee profile pattern data may comprise one or more prestored keyword patterns representing the technology. The one or more prestored keyword patterns comprise at least a singular keyword pattern and Boolean keyword patterns. The Boolean keyword patterns comprise the keyword and one or more keywords related to the keyword used in combination with a set of logical operators. The set of logical operators comprises at least one of “AND”, “OR”, and “NOT” logical operators. It may be noted that the one or more keywords represent a predefined context for the technology.

In particular embodiments, the system 102 may create vector space between the keyword and the set of buffer keywords. Further, distance between the keyword and the set of buffer keywords may be determined in order to match whether the keyword and the set of buffer keywords are within a threshold distance from each other in terms of a similarity metric. The system may calculate a similarity metric of vectors in vector space 600. A similarity metric may be a cosine similarity, a Minkowski distance, a Mahalanobis distance, a Jaccard similarity coefficient, or any suitable similarity metric. The similarity metric of two vectors may represent how similar the two objects or n-grams corresponding to the two vectors, respectively, are to one another, as measured by the distance between the two vectors in the vector space 600.

In an example and not by way of any limitation, let us assume that keyword is technology P, and the set of buffer keywords are group collaboration, project management, and health management. The system may create the vector space between technology P and group collaboration, project management and health management. In the example, the distance between the technology P and group collaboration, similarly technology P and project management may be within the predefined threshold.

As an example, and not by way of limitation, vector 610 (technology P) and vector 620 (group collaboration) may correspond to objects that are more similar to one another than the objects corresponding to vector 610 (technology P) and vector 630 (health management), based on the distance between the respective vectors. Although this disclosure describes calculating a similarity metric between vectors in a particular manner, this disclosure contemplates calculating a similarity metric between vectors in any suitable manner.

JavaScript (JS) Rendering

Often, the system may not extract patterns from the HTML pages because the number of dynamic web sites is increasing daily. The patterns may lie in JavaScript (JS) content, which requires the fetch. To extract the patterns from the dynamic web address or websites, the system 102 may receive the list of the web addresses. It may be noted that JS pattern data may be stored in the system. Further, a python script with parallel processing may read the list of web addresses and extract the JS content from a browser (e.g., Chrome® Browser). Furthermore, a driver (e.g., chromium driver) may be used to extract patterns from the different libraries being used and stored in the memory for extracting the required patterns from the JS patterns data. Finally, the system may create a JS pattern file comprising the list of the web address associated with the company identifier mapped to patterns related to the technology.

NS lookup, MX lookup and TXT Records

Domain Name Server (DNS) Records for any particular domain or web address provide information related to the technologies that the company may be using. The most common technologies may comprise Web Hosting Services and Email Services. It may be noted that various kinds of DNS Records such as Name Server Record (NS Record) & Mail-Exchange record (MX record) may be used to identify the Web Hosting Services and the Email Services used by the company. The Name Server Record indicates which DNS server is authoritative for that domain or web address. The mail exchanger record (MX record) specifies the mail server responsible for accepting email messages on behalf of the domain or web address. TXT records are a type of Domain Name System (DNS) record that contains text information for sources outside the domain.

After receiving the list of the web address, the system may run a python script with multiprocessing to read the list of the web address. Further, NS record data, MX record data and TXT Record data are extracted by using a UNIX domain information groper (dig) command. The extracted data is stored in the memory.

Further, the NS record data, MX record data and TXT record data may be compared with a predefined pattern data of NS record, MX record, and TXT record respectively. In an example, Aho-Corasick algorithm may be used for pattern matching. In an example and not by way of any limitation, the system may run another python script to scan NS record data, MX record data and TXT record data for matches with the predefined pattern data of NS Record, MX Record, and TXT record.

When the extracted data matches with the predefined pattern data of NS Record, MX Record, and TXT record data, the NS record data, MX record data, and TXT record data are tagged to the company identifier. It may be noted that the UNIX command dig is used for querying DNS nameservers for information about host addresses, mail exchanges, nameservers, and related information.

Human Curated Data

In an embodiment, a user may browse thousands of websites in order to determine the technology currently being used by the company. It may be noted that the accuracy of the human-curated data is very high compared to job listing data and employee profile data analysis.

Further to extraction using a set of techniques, the system 102 may validate the patterns in real time by comparing the extracted patterns with the prestored pattern file of each technique. The prestored pattern file may comprise a list of predefined patterns for each technique. The pattern file may comprise the information for mapping the patterns to the technology. It may be noted that each pattern is different for the same technology for different techniques.

In an embodiment, the list of HTML patterns may be validated by comparing with the HTML pattern file. Likewise, the job listing, and employee profile pattern file may be compared with the prestored pattern data of job listing and employee profile. In an example and not by way of any limitation, Aho-Corasick algorithm may be used to compare the extracted patterns and the predefined patterns of each technique.

Further to validating, the system 102 may compile files created from each technique to generate compiled data. The compiled data may comprise a mapping of the patterns related to the technology with the corresponding set of techniques against the company identifier. In an embodiment, the compiled data may also comprise a timestamp for the technology. The timestamp shows the last detected time for a particular technology. For an example, the timestamp may show that company A started using technology P in March 2020.

Further to compiling, the system 102 may identify the technology currently being used by the company by comparing the compiled data with a prestored pattern file of each technique. The compiled data may be compared with the pattern file for each technique using a set of string matching algorithms.

In an embodiment, the system may classify the technology in at least a category and a subcategory. For example, let's assume that the system identifies that company A uses a technology named Technology P. The system may determine that the technology P is used for Communication purposes. Further, the system may determine the subcategory of the technology P. Let us assume that subcategory may be Group Collaboration, Project Management, and likewise.

It may be noted that the system may receive the data from the set of techniques in a different format and type. Thus, it becomes essential to unify the data. It may be noted that each technique returns the data in a raw format comprising patterns attached to the company identifier. It may be noted that the patterns must be mapped to the names of the technologies the pattern represents. In an embodiment, some patterns may require exclusion based on research conducted on such patterns.

The data from each technique may be stored in the memory 112 or a data lake. Since each technique has the pattern file or the signature file, similarly for mapping data of each technique, a different code chunk acts on the respective technique data. In an embodiment, a spark code may be executed on a cluster to map all the signature file or the pattern file to the respective technology while preserving the techniques and the company identifier it is tagged to. It may be noted that the data from all the techniques are combined and written as parquet files into the data lake partitioned by the date for further analysis and downstream processing.

After compiling the data from the set of techniques, the compiled data may be injected into the algorithm. In an embodiment, the spark cluster may be used from the start of this process to the end. In an embodiment, the compiled data may comprise the technology, and the company id mapped to a technology master file.

In particular embodiments, the system may calculate technology movement for the technology. The technology movement means the displacement of an existing technology by a new technology in a specific subcategory. Let us assume that company A has been using technology Z for Project Management (subcategory) since March 2021. Further, let us assume that the system generates newly compiled data in March 2022, comprising a new technology for the same subcategory (Project Management). Let us assume that company A shifts from technology Z to technology Y. The system may also record when the technology Z and Y were last detected.

In an example, the newly compiled data may be compared with the previously existing compiled data to modify the compiled data. The modification may include inserting new data points, deleting existing data points, and updating existing data points. It may be noted that the newly compiled data is compared with the previously existing compiled data to arrive at derivatives or detect technology movements. In an embodiment, the technology movement is defined only when the below conditions are met:
Only one technology had existed in the specific subcategory for a company; and
One new technology has displaced the single existing technology in the subcategory (above condition).

Further to identifying the technology, the system may calculate a confidence score for the identified technology. The confidence score may be calculated based on a rule-based model corresponding to the set of techniques. It may be noted that the confidence score is calculated based on type of techniques, number of techniques used to successfully identify the patterns, and time of detection of the technology. It may be noted that each technique may be allotted a predefined weightage.

In another embodiment, the confidence score may be an average of a technique score of the set of techniques and a last detected score. The last detected score may be calculated based on the time of detection of the technology.

In an example and not by way of any limitation, a user may define weightage for each technique. Let us assume that the weightage given to each technique are:

| Technique | Weightage |
|---|---|
| HTML Crawling | 40% |
| Subdomain Checker | 50% |
| NS lookup, MX lookup and TXT Records | 50% |
| Human Curated | 70% |
| JS Rendering | 35% |
| Employee Profile Data | 25% |
| Job Listing Data | 10% |

In the above example, the system may also consider the time of detection of the technology or the last detected date of the technology to calculate the confidence score. It may be noted that the confidence score is calculated for each technology.

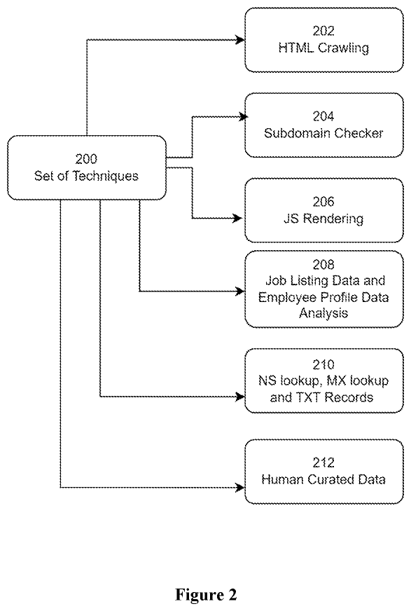

Referring now to FIG. 2 (200), a set of techniques for extracting patterns related to the technology is shown. The patterns may be extracted by 202 HTML Crawling, 204 subdomain checker, 206 JS Rendering, 208 job listing data and employee profile data analysis, 210 NS lookup, MX lookup and TXT Records, and 212 Human Curated Data. It may be noted that the set of techniques is used to increase the efficiency of the system. In an embodiment, the system may also work when the patterns are extracted from only one technique.

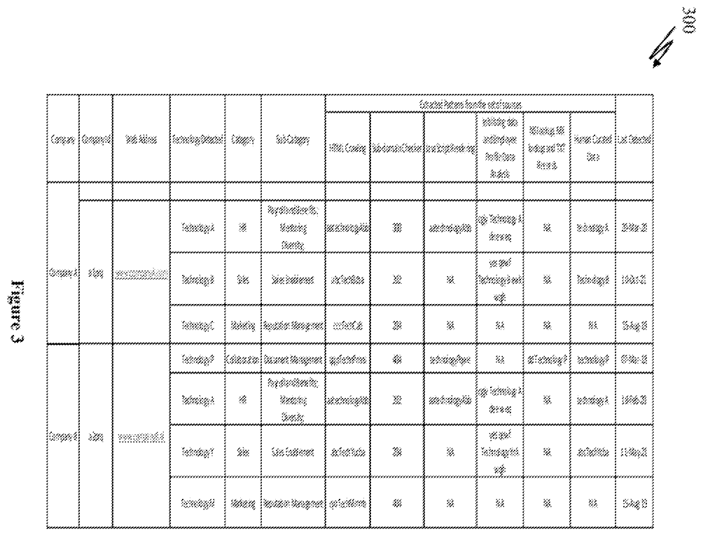

Referring now to FIG. 3, an example of compiled data is shown. The compiled data comprises a company name, a company identifier, a web address, a set of techniques, patterns extracted from the set of techniques, the last detection time of a technology. The system may extract one or more technologies used by the company. In order to do so, the system may parse web address of the company using the set of techniques. Further, each technique extracts patterns related to the technology. It may be noted that each technique creates a file comprising the patterns attached to the company identifier. The system may compile files from each technique to generate compiled data. The system also classifies the technology into at least a category and a subcategory. In FIG. 3, it can be seen that company A is using technology A. Further, technology A is classified into Human Resource (HR) and, more specifically, Payroll and Benefits, Mentoring, and Diversity. It means that company A uses technology A for Payroll and Benefits, Mentoring, and Diversity purposes. Similarly, company B is using technology Y for Sales Enablement.

The compiled data also comprises the last detection date. The last detection date or time of detection of the technology is the time when the system detected a particular technology. The compiled data also comprises patterns extracted from each technique. It may be noted that each pattern is different for the same technology for different techniques.

In an example, the system, for every run (scan), stores the timestamp of the technology detection for the company. It may be noted that each specific company and the technology has a unique identifier (primary key). Let us assume that in the subsequent run if the same combination of the technology and the company is detected again, the last detection date is updated to the latest one for the technology company combination, if not then the last detection date remains the same until the last detected date is more than six months ago.

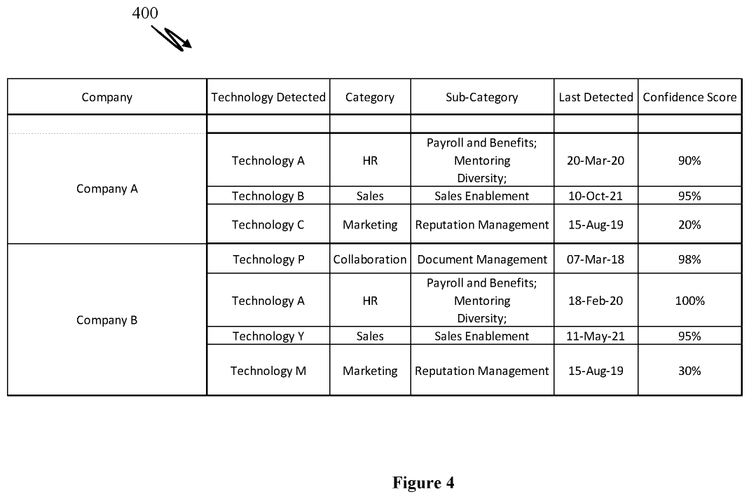

Referring now to FIG. 4, an example 400 of the technographic data is shown. The technographic data may comprise at least a company, a technology detected from the set of techniques, a category, a subcategory, the last detection date or time of detection of the technology, and a confidence score. The system displays the technographic data to the user. It may be noted that the system identifies, in real time, technographic data for millions of webpages by extracting patterns from the set of techniques. The confidence score is calculated based on the type of techniques, number of techniques used to successfully identify the patterns, and the time of detection of the technology.

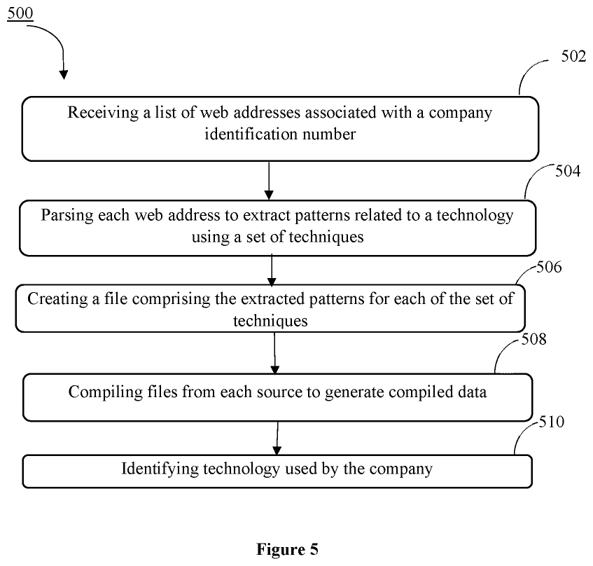

Referring now to FIG. 5 method 500 for identifying technology used by a company is shown, in accordance with an embodiment of the present subject matter. The method 500 may be described in the general context of computer executable instructions. Generally, computer executable instructions can include routines, programs, objects, components, data structures, procedures, modules, functions, etc., that perform particular functions or implement particular abstract data types.

The order in which the method 500 is described is not intended to be construed as a limitation, and any number of the described method blocks can be combined in any order to implement the method 500 or alternate methods for identifying technology used by a company. Additionally, individual blocks may be deleted from the method 500 without departing from the scope of the subject matter described herein. Furthermore, the method 500 for identifying technology used by a company can be implemented in any suitable hardware, software, firmware, or combination thereof. However, for ease of explanation, in the embodiments described below, the method 500 may be considered to be implemented in the above-described system 102.

At block 502, a list of web addresses associated with a company identifier may be received.

At block 504, each web address may be parsed to extract patterns related to the technology using a set of techniques. The set of techniques comprising HyperText Markup Language (HTML) crawling, subdomain check, job listing data and employee profile data analysis, JavaScript (JS) rendering, Name Server (NS) lookup, Mail Exchange (MX) lookup, and Text (TXT) Records.

At block 506, a file comprising the extracted patterns for each of the set of techniques may be created.

At block 508, the files created for each technique may be compiled to generate compiled data. The compiled data may comprise a mapping of the patterns related to the technology with the corresponding set of techniques against the company identifier.

At block 510, the technology currently being used by the company may be identified by comparing the compiled data with a prestored pattern file of each technique. The compiled data may be compared with the pattern file for each technique using a set of string matching algorithms.

Exemplary embodiments discussed above may provide certain advantages. Though not required to practice aspects of the disclosure, these advantages may include those provided by the following features.

Some embodiments of the system and the method helps identify the technographic data in real-time for the company.

Some embodiments of the system and the method identify the technographic data by parsing the web address using HTML Crawling, Subdomain Checker, and JavaScript Rendering.

Some embodiments of the system and the method generate insights related to technologies being used by the company.

Some embodiments of the system and the method calculate confidence score based on the type of techniques, number of techniques used to successfully identify the patterns, and the time of detection of the technology.

Some embodiments of the system and the method help an organization understand buyer behaviour and pain points using buyer journeys and technographic insights.

Some embodiments of the system and the method assist the organization to identify accurate leads for a particular product or service.

Although implementations for methods and systems for identifying technology used by a company have been described in language specific to structural features and/or methods, it is to be understood that the appended claims are not necessarily limited to the specific features or methods described. Rather, the specific features and methods are disclosed as examples of implementations for identifying the technology used by a company.

1. A method for identifying technology used by a company, the method comprising:
receiving, by a processor, a list of web addresses associated with a company identifier;
parsing, by the processor, each web address to extract patterns related to a technology using a set of techniques;
creating, by the processor, a file comprising the extracted patterns for at least one technique of the set of techniques, and wherein the at least one technique is a sub-domain check comprising:
creating a plurality of pseudo uniform resource locators (URLs) for each web address by invoking a sub-domain template file, corresponding to different technologies, stored in a memory,
splitting the pseudo URLs among clusters based on a rate-limiting factor and a request-response time,
visiting the plurality of pseudo URLs parallelly by using a right parallelism technique,
determining a status code for each visited pseudo URL as one of positive or negative, wherein the status code is indicative of whether the technology is being used by the company, and
creating a sub-domain pattern file comprising the technology and status code tagged to each company identifier;
compiling, by the processor, the files created for each technique to generate compiled data, and wherein the compiled data comprises a mapping of the extracted patterns related to the technology with the corresponding set of techniques against the company identifier; and
identifying, by the processor, the technology currently being used by the company by comparing the extracted patterns in the compiled data with a prestored pattern file for each technique.

2. The method as claimed in claim 1, wherein the patterns are extracted from the set of techniques comprising HyperText Markup Language (HTML) crawling, subdomain check, job listing data and employee profile data analysis, JavaScript (JS) rendering, Name Server (NS) lookup, Mail Exchange (MX) lookup, and Text (TXT) Records.

3. The method as claimed in claim 1, wherein the prestored pattern file comprises information for mapping the patterns to the technology, and wherein each predefined pattern is different for different techniques.

4. The method as claimed in claim 1, wherein the extracted patterns in the compiled data is compared with predefined patterns in the pattern file for each technique using a set of string matching algorithms.

5. The method as claimed in claim 1, further comprising: calculating a confidence score for the identified technology based on the compiled data, wherein the confidence score is calculated based on a rule-based model corresponding to the set of techniques.

6. The method as claimed in claim 5, wherein the confidence score is calculated based on at least one of: type of techniques, a number of techniques used to successfully identify the patterns, and time of detection of the technology, and wherein each technique is allotted a predefined weightage.

7. The method as claimed in claim 1, wherein the parsing each web address to extract patterns using a set of techniques comprises:
crawling different levels of each web address;
based on the crawling, extracting Hypertext Markup Language (HTML) data pertaining to each level of the web address, wherein the HTML data is stored in a storage unit; and
extracting a list of HTML patterns for each company based on the HTML data, wherein the list of HTML patterns is extracted by comparing the list of HTML patterns with a prestored HTML pattern file.

8. The method as claimed in claim 1, wherein the
rate-limiting factor refers to preventing the frequency of an operation from exceeding a constraint, and wherein the request response time refers to a time that starts when a request to visit the pseudo URL is initiated and ends when the request is completed.

9. The method as claimed in claim 1, wherein the subdomain template represents a URL format for the technology.

10. The method as claimed in claim 1, wherein creating the pseudo URL for each company comprises:
invoking the subdomain template corresponding to different technologies, wherein the subdomain template is a combination of at least a technology field, a company field, a domain extension, alphabets, numbers, and special characters; and
replacing the company field in the subdomain template with at least a company name corresponding to each company.

11. The method as claimed in claim 1, wherein the parsing each web address to extract patterns using a set of techniques comprises:
obtaining job listing data and employee profile data;
extracting a keyword and a set of buffer keywords from the job listing data and the employee profile data;
determining context of the job listing data and the employee profile data based on the set of buffer keywords related to the keyword;
comparing the keyword and the context with corresponding prestored job listing pattern data and prestored employee profile pattern data; and
creating a job listing pattern file and an employee profile pattern file when a match is found.

12. The method as claimed in claim 11, wherein the set of buffer keywords comprises a plurality of words appearing before and after the keyword in either the job listing data or the employee profile data.

13. The method as claimed in claim 11, wherein the context of the set of buffer keywords is determined using Machine Learning techniques.

14. The method as claimed in claim 11, wherein the employee profile data comprises at least a current work profile and past work profile of an employee, wherein the employee is currently employed with the company.

15. The method as claimed in claim 11, wherein the prestored job listing pattern data and prestored employee profile pattern data comprises at least a singular keyword pattern and a Boolean keyword pattern.

16. The method as claimed in claim 15, wherein the Boolean keyword pattern comprises the keyword and one or more keywords related to the keyword used in combination with a set of logical operators, and wherein the set of logical operators comprise at least one of “AND”, “OR”, and “NOT” logical operators.

17. A system for identifying technology used by a company, the system comprises:
a memory; and
a processor coupled to the memory, wherein the processor is configured to execute program instructions stored in the memory for:
receiving a list of web addresses associated with a company identifier;
parsing each web address to extract patterns related to the technology using a set of techniques;
creating a file comprising the extracted patterns for at least one technique of the set of techniques, and wherein the at least one technique is a sub-domain check comprising:
creating a plurality of pseudo uniform resource locators (URLs) for each web address by invoking a sub-domain template file, corresponding to different technologies, stored in a memory,
splitting the pseudo URLs among clusters based on a rate-limiting factor and a request-response time,
visiting the plurality of pseudo URLs parallelly by using a right parallelism technique,
determining a status code for each visited pseudo URL as one of positive or negative, wherein the status code is indicative of whether the technology is being used by the company, and
creating a sub-domain pattern file comprising the technology and status code tagged to each company identifier;
compiling files created for each technique to generate compiled data, and wherein the compiled data comprises a mapping of the extracted patterns related to the technology with the corresponding set of techniques against the company identifier; and
identifying the technology currently being used by the company by comparing the extracted patterns in the compiled data with a prestored pattern file for each technique.

18. The system as claimed in claim 17, wherein the patterns are extracted from the set of techniques comprising HyperText Markup Language (HTML) crawling, subdomain check, job listing data and employee profile data analysis, JavaScript (JS) rendering, Name Server (NS) lookup, Mail Exchange (MX) lookup, and Text (TXT) Records.

19. The system as claimed in claim 17, wherein the prestored pattern file comprises information for mapping the patterns to the technology, and wherein each pattern is different for same technology for different techniques.

20. The system as claimed in claim 17, wherein the extracted patterns in the compiled data is compared with predefined patterns in the pattern file for each technique using a set of string matching algorithms.

21. The system as claimed in claim 17, further comprising: calculating a confidence score for the identified technology based on the compiled data, wherein the confidence score is calculated based on a rule-based model corresponding to the set of techniques.

22. The system as claimed in claim 21, wherein the confidence score is calculated based on at least one of type of techniques, number of techniques used to successfully identify the patterns, and time of detection of the technology, and wherein each technique is allotted a predefined weightage.

23. The system as claimed in claim 17, wherein the parsing each web address to extract patterns using a set of techniques comprises:
crawling different levels of each web address;
based on the crawling, extracting Hypertext Markup Language (HTML) data pertaining to each level of the web address, wherein the HTML data is stored in a storage unit; and
extracting a list of HTML patterns for each company based on the HTML data, wherein the list of HTML patterns is extracted by comparing the list of HTML patterns with a prestored HTML pattern file.

24. The system as claimed in claim 17, wherein the
rate-limiting factor refers to preventing the frequency of an operation from exceeding a constraint, and wherein the request response time refers to a time that starts when a request to visit the pseudo URL is initiated and ends when the request is completed.

25. The system as claimed in claim 17, wherein the subdomain template represents a URL format for the technology.

26. The system as claimed in claim 17, wherein creating the pseudo URL for each company comprises:
invoking the subdomain templates corresponding to different technologies, wherein the subdomain template is a combination of at least a technology field, a company field, a domain extension, alphabets, numbers, and special characters; and
replacing the company field in the subdomain template with at least a company name corresponding to each company.

27. The system as claimed in claim 17, wherein the parsing each web address to extract patterns using a set of techniques comprises:
obtaining job listing data and employee profile data;
extracting a keyword and a set of buffer keywords from the job listing data and the employee profile data;
determining context of the job listing data and the employee profile data based on the set of buffer keywords related to the keyword, wherein the context of the set of buffer keywords is determined using Machine Learning techniques;
comparing the keyword and the context with corresponding prestored job listing pattern data and prestored employee profile pattern data; and
creating a job listing pattern file and an employee profile pattern file when a match is found.

28. The system as claimed in claim 27, wherein the set of buffer keywords comprises a plurality of words appearing before and after the keyword in either the job listing data or the employee profile data.

29. The system as claimed in claim 27, wherein the prestored job listing pattern data and prestored employee profile pattern data comprises at least a singular keyword pattern and a Boolean keyword pattern, and wherein the Boolean keyword pattern comprises the keyword and one or more keywords related to the keyword used in combination with a set of logical operators, and wherein the set of logical.

30. A non-transitory computer program product having embodied thereon a computer program for identifying technology used by a company, the computer program product storing instructions for:
receiving a list of web addresses associated with a company identifier;
parsing each web address to extract patterns related to the technology using a set of techniques;
creating a file comprising the extracted patterns for at least one technique of the set of techniques, and wherein the at least one technique is a sub-domain check comprising:
creating a plurality of pseudo uniform resource locators (URLs) for each web address by invoking a sub-domain template file, corresponding to different technologies, stored in a memory,
splitting the pseudo URLs among clusters based on a rate-limiting factor and a request-response time,
visiting the plurality of pseudo URLs parallelly by using a right parallelism technique,
determining a status code for each visited pseudo URL as one of positive or negative, wherein the status code is indicative of whether the technology is being used by the company, and
creating a sub-domain pattern file comprising the technology and status code tagged to each company identifier;
compiling files created for each technique to generate compiled data, and wherein the compiled data comprises a mapping of the extracted patterns related to the technology with the corresponding set of techniques against the company identifier; and
identifying the technology currently being used by the company by comparing the extracted patterns in the compiled data with a prestored pattern file for each technique.
